(19) United States
(12) Patent Application Publication
(10) Pub. No.: US 2026/0365545 A1
(43) Pub. Date: Nov. 19, 2026

(54) WATER FILTER

(71) Applicant: GLOBAL INDUSTRIAL DISTRIBUTION INC., Port Washington, NY (US)

(72) Inventors: Richard B. LEEDS, Port Washington, NY (US); Bruce B. ZUTLER, Port Washington, NY (US)

(73) Assignee: GLOBAL INDUSTRIAL DISTRIBUTION INC., Port Washington, NY (US)

(21) Appl. No.: 19/210,128

(22) Filed: May 16, 2025

(51) Int. Cl. C02F 1/00; C02F 1/58; C02F 101/36

(52) U.S. Cl. CPC C02F 1/003; C02F 1/583; C02F 2101/36

(57) ABSTRACT

A water filter capable of filtering various forever chemicals, such as perfluoroalkyl and polyfluoroalkyl substances (PFAS) and microplastics. The water filter has a life cycle capacity of at least 3400 gallons and operates at a flow rate of at least 1.2 gallons per minute.

### FIELD

The present invention relates to a water filter.

### BACKGROUND

Water filters capable of filtering various forever chemicals, such as perfluoroalkyl and polyfluoroalkyl substances (PFAS), and microplastics may have limited capacities, and therefore may require frequent replacement with new water filters

A need exists for water filter capable of filtering water and having a life cycle capacity of at least 3400 gallons. Embodiments of the present disclosure are directed to this and other considerations.

### SUMMARY

A water filter is disclosed. According to some examples, the water filter has a life cycle capacity of at least 3600 gallons. In some examples the water filter filters water from a water source at least at 1.2 gallons per minute. The water filter may have a length of about 9.75 inches. The water filter may have a diameter of about 3.25 inches. In some examples the water filter operates at a pressure of about 10 pounds per square inch to about 105 pounds per square inch.

In some examples, the water filter removes perfluorinated and polyfluorinated substances (PFAS) from the water source. The water filter may remove perfluorooctanoic acid (PFOA), perfluorooctane sulfonic acid (PFOS), perfluorononanoic acid (PFNA), perfluorohexanesulfonic acid (PFHxS), and perfluoroheptanoic acid (PFHpA). In some examples, the water filter removes microplastics from the water source. The water filter may remove particles greater than or equal to 1 micron. In some examples, the water filter removes particles greater than or equal to 0.5 microns. In some examples, the water filter removes lead, cyst, chlorine, and turbidity.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a perspective view of a water, according to certain embodiments of the present disclosure.

FIG. 2 is a side view of the water filter, according to certain embodiments of the present disclosure.

FIG. 3 is a top view of the water filter, according to certain embodiments of the present disclosure.

FIG. 4 is a bottom view of the water filter, according to certain embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices and methods. Such other components not described herein may include, but are not limited to, for example, components developed after development of the disclosed technology.

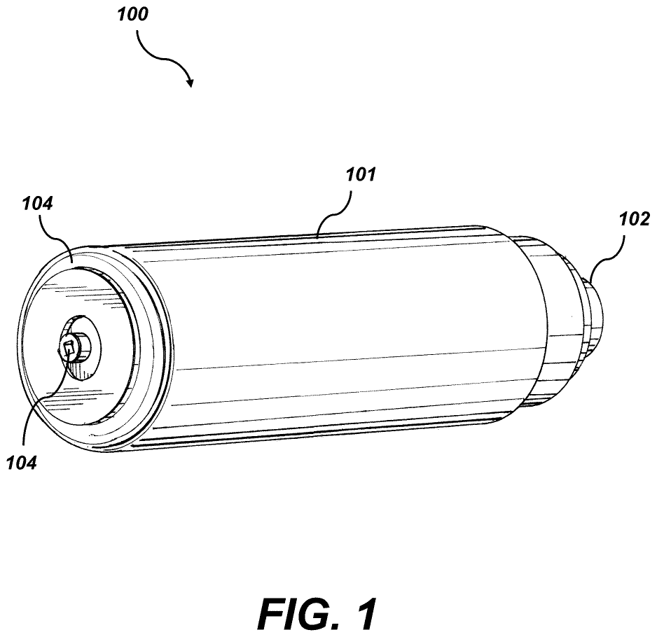

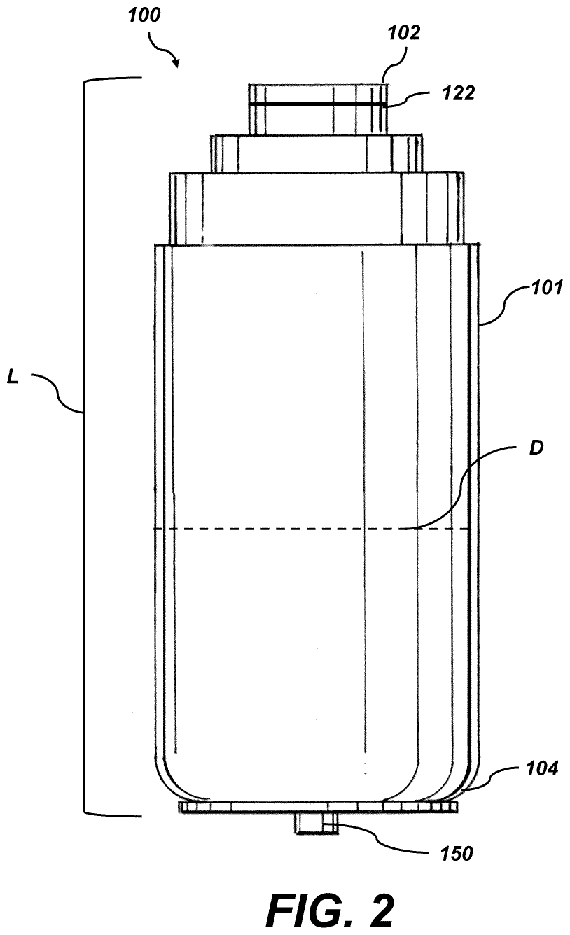

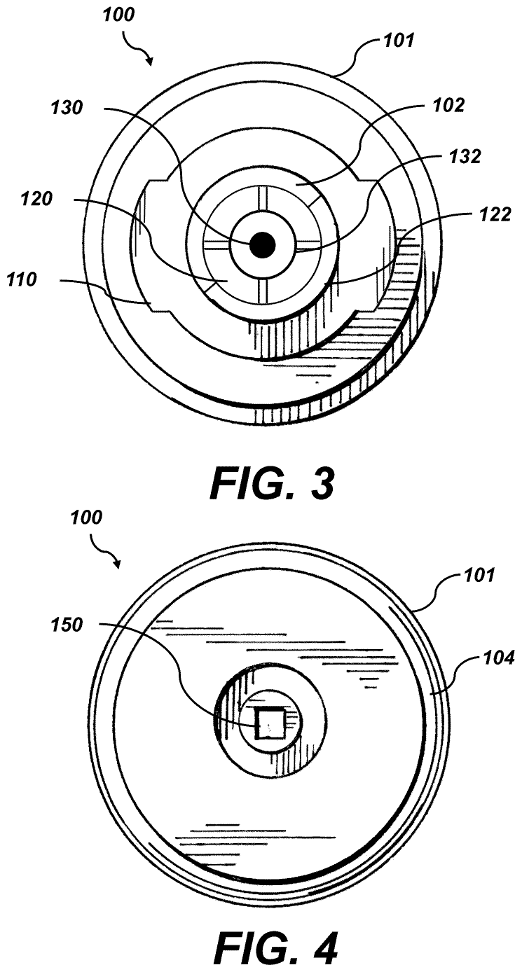

Reference will now be made in detail to exemplary embodiments of the disclosed technology, examples of which are illustrated in FIGS. 1-4, and disclosed herein. Wherever convenient, the same reference numbers will be used throughout the drawings to refer to the same or like parts.

FIGS. 1-4 depict a water filter 100 configured to filter water, according to some examples. The water filter 100 may be configured to be removably coupled to a water filtration system. In some examples, the water filter 100 is configured to filter water for a water bottle refilling station. In some examples, the water filter 100 has a life cycle capacity of at least about 2500 gallons. In some examples, the water filter 100 has a life cycle capacity of at least about 3400 gallons. In some examples, the water filter 100 has a life cycle capacity of at least about 3600 gallons. In some examples, the water filter 100 is configured to filter water from a water source at least at about 1.2 gallons per minute and has a life cycle capacity of at least about 3600 gallons.

In some examples, the water filter 100 comprises a body 101 having a top end 102 and a bottom end 104. In some examples, the body 101 is substantially cylindrical. In some examples, the body 101 of the water filter 100 has a length L of approximately 9.75 inches or about 24.75 centimeters. In some examples, the body 101 of the water filter 100 has a diameter D of approximately 3.25 inches or about 8.25 centimeters.

In some examples, the top end 102 of the water filter 100 comprises an inlet 120 for receiving water from a water source. In some examples, the water source is pressurized and the water filter has an operating pressure of about 10 pounds per square inch to about 105 pounds per square inch into the inlet 120. In some examples, the top end 102 of the water filter 100 comprises an outlet 130 where filtered water exits the water filter 100. Seals 122, 132 may be provided at the top end 102 of the water filter 100 to seal the filter and prevent leaks when the water filter is coupled to a water filtration system. Tabs 110 may be provided at the top end 102 of the water filter 100 to engage and lock the water filter 100 into a water filtration system. In some examples, the tabs 110 are configured to couple the water filter 100 to a water filtration system with a quarter-turn or 90-degree rotation.

In some examples, the water filter 100 is configured to filter water from a water source at 1.2 gallons per minute and has a life cycle capacity of at least 3600 gallons. In some examples, the water filter 100 removes perfluorinated and polyfluorinated substances (PFAS) from the water source. PFAS removed by the water filter 100 may include perfluorooctanoic acid (PFOA), perfluorooctane sulfonic acid (PFOS), perfluorononanoic acid (PFNA), perfluorohexanesulfonic acid (PFHxS), and perfluoroheptanoic acid (PFHpA). In some examples, the water filter 100 reduces total PFAS concentration by about 98.6%, where an influent concentration is 0.00216+/−20 %.

The water filter 100 may remove microplastics from a water source. In some examples, the water filter 100 reduces the amount of microplastics by about 98.6%, where an influent concentration is at least 10000 particles per milliliter. In some examples, the water filter 100 removes particles greater than or equal to 1 micron. In some examples, the water filter removes particles greater than or equal to 0.5 microns.

The water filter 100 may remove chlorine from a water source to reduce chlorine taste and odor. In some examples, the water filter 100 reduces chlorine by about 98.78%, where an influent concentration is 2.0±10% milligrams per liter.

The water filter 100 may remove lead from a water source. In some examples, the water filter 100 reduces pH 6.5 lead by about 99.70%, where an influent concentration is 1.5±10% milligrams per liter. In some examples, the water filter 100 reduces pH 8.5 lead by about 99.24%, where an influent concentration is 1.5±10% milligrams per liter.

The water filter 100 may remove cyst from a water source. In some examples, the water filter 100 reduces cyst by about 99.99%, where an influent concentration is at least 50,000 parts per liter.

The water filter 100 may remove turbidity from a water source to reduce cloudiness. In some examples, the water filter 100 reduces turbidity by at least 99.5%, where an influent concentration is 11±1 Nephelometric Turbidity Units (NTU).

In some examples, a bottom end 104 of the water filter 100 comprises a key 150. Key 150 may be used to unlock an access door of a water filtration system or water bottle refill station. U.S. Pat. No. 11,724,221, which is incorporated herein by reference, describes a system using key 150 in a corresponding key hole provided on an access door of a water filtration system.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g., “about 90%” may refer to the range of values from 71% to 99%.

The disclosed technology described herein can be further understood according to the following clauses:
Clause 1: A water filter configured to filter water from a water source at least at 1.2 gallons per minute and having a life cycle capacity of at least about 3400 gallons.
Clause 2: The water filter of Clause 1, wherein the water filter comprises a length of about 9.75 inches.
Clause 3: The water filter of Clause 1 or 2, wherein the water filter comprises a diameter of about 3.25 inches.
Clause 4: The water filter of any one of Clauses 1 to 3, wherein an operating pressure of the water filter is about 10 pounds per square inch to about 105 pounds per square inch.
Clause 5: The water filter of any one of Clauses 1 to 4, wherein the water filter removes perfluorinated and polyfluorinated substances (PFAS) from the water source.
Clause 6: The water filter of Clause 5, wherein the water filter removes perfluorooctanoic acid (PFOA), perfluorooctane sulfonic acid (PFOS), perfluorononanoic acid (PFNA), perfluorohexanesulfonic acid (PFHxS), and perfluoroheptanoic acid (PFHpA).
Clause 7: The water filter of any one of Clauses 1 to 6, wherein the water filter removes microplastics from the water source.
Clause 8: The water filter of any one of Clauses 1 to 7, wherein the water filter removes particles greater than or equal to 1 micron.
Clause 9: The water filter of Clause 7, wherein the water filter removes particles greater than or equal to 0.5 microns.
Clause 10: The water filter of any one of Clauses 1 to 9, wherein the water filter removes lead, cyst, chlorine, and turbidity.
Clause 11: A water filter configured to filter water from a water source at least at 1.2 gallons per minute and having a life cycle capacity of at least about 3600 gallons.
Clause 12: The water filter of Clause 11, wherein the water filter comprises a length of about 9.75 inches.
Clause 13: The water filter of Clause 11 or 12, wherein the water filter comprises a diameter of about 3.25 inches.
Clause 14: The water filter of any one of Clauses 11 to 13, wherein an operating pressure of the water filter is about 10 pounds per square inch to about 105 pounds per square inch.
Clause 15: The water filter of any one of Clauses 11 to 14, wherein the water filter removes perfluorinated and polyfluorinated substances (PFAS) from the water source.
Clause 16: The water filter of Clause 15, wherein the water filter removes perfluorooctanoic acid (PFOA), perfluorooctane sulfonic acid (PFOS), perfluorononanoic acid (PFNA), perfluorohexanesulfonic acid (PFHxS), and perfluoroheptanoic acid (PFHpA).
Clause 17: The water filter of any one of Clauses 11 to 16, wherein the water filter removes microplastics from the water source.
Clause 18: The water filter of any one of Clauses 11 to 17, wherein the water filter removes particles greater than or equal to 1 micron.
Clause 19: The water filter of Clause 17, wherein the water filter removes particles greater than or equal to 0.5 microns.
Clause 20: The water filter of any one of Clauses 11 to 19, wherein the water filter removes lead, cyst, chlorine, and turbidity.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A water filter configured to filter water from a water source at least at 1.2 gallons per minute and having a life cycle capacity of at least about 3400 gallons.

2. The water filter of claim 1, wherein the water filter comprises a length of about 9.75 inches.

3. The water filter of claim 2, wherein the water filter comprises a diameter of about 3.25 inches.

4. The water filter of claim 1, wherein an operating pressure of the water filter is about 10 pounds per square inch to about 105 pounds per square inch.

5. The water filter of claim 1, wherein the water filter removes perfluorinated and polyfluorinated substances (PFAS) from the water source.

6. The water filter of claim 5, wherein the water filter removes perfluorooctanoic acid (PFOA), perfluorooctane sulfonic acid (PFOS), perfluorononanoic acid (PFNA), perfluorohexanesulfonic acid (PFHxS), and perfluoroheptanoic acid (PFHpA).

7. The water filter of claim 1, wherein the water filter removes microplastics from the water source.

8. The water filter of claim 1, wherein the water filter removes particles greater than or equal to 1 micron.

9. The water filter of claim 7, wherein the water filter removes particles greater than or equal to 0.5 microns.

10. The water filter of claim 1, wherein the water filter removes lead, cyst, chlorine, and turbidity.

11. A water filter configured to filter water from a water source at least at 1.2 gallons per minute and having a life cycle capacity of at least about 3600 gallons.

12. The water filter of claim 11, wherein the water filter comprises a length of about 9.75 inches.

13. The water filter of claim 12, wherein the water filter comprises a diameter of about 3.25 inches.

14. The water filter of claim 11, wherein an operating pressure of the water filter is about 10 pounds per square inch to about 105 pounds per square inch.

15. The water filter of claim 11, wherein the water filter removes perfluorinated and polyfluorinated substances (PFAS) from the water source.

16. The water filter of claim 15, wherein the water filter removes perfluorooctanoic acid (PFOA), perfluorooctane sulfonic acid (PFOS), perfluorononanoic acid (PFNA), perfluorohexanesulfonic acid (PFHxS), and perfluoroheptanoic acid (PFHpA).

17. The water filter of claim 11, wherein the water filter removes microplastics from the water source.

18. The water filter of claim 11, wherein the water filter removes particles greater than or equal to 1 micron.

19. The water filter of claim 17, wherein the water filter removes particles greater than or equal to 0.5 microns.

20. The water filter of claim 11, wherein the water filter removes lead, cyst, chlorine, and turbidity.
